(19) United States
(12) Patent Application Publication
(10) Pub. No.: US 2001/0051872 A1
(43) Pub. Date: Dec. 13, 2001

(54) CLUSTERED PATTERNS FOR TEXT-TO-SPEECH SYNTHESIS

(76) Inventors: TAKEHIKO KAGOSHIMA, HYOGO-KEN (JP); TAKAAKI NII, OSAKA-FU (JP); SHIGENOBU SETO, HYOGO-KEN (JP); MASAHIRO MORITA, HYOGO-KEN (JP); MASAMI AKAMINE, HYOGO-KEN (JP); YOSHINORI SHIGA, KANAGAWA-KEN (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/149,036

(22) Filed: Sep. 8, 1998

(30) Foreign Application Priority Data
Sep. 16, 1997 (JP) P09-250496

(51) Int. Cl. G10L 13/00; G10L 13/08

(52) U.S. Cl. 704/260

(57) ABSTRACT

A speech information processing apparatus previously stores a plurality of representative patterns corresponding to each cluster to which prosody unit belongs. A clustering section classifies a plurality of prosody units in speech data to each cluster according to attribute data of the prosody unit. An extraction section extracts pitch pattern corresponding to the prosody unit classified to each cluster from the speech data. A transformation parameter generation section generates a transformation parameter by evaluating error between the pitch pattern and transformed representative pattern by unit of the cluster. A representative pattern generation section updately generates the representative pattern by calculating an evaluation function of the pitch pattern and the transformation parameter by unit of the cluster.

### FIELD OF THE INVENTION

The present invention relates to a speech information processing apparatus and a method to generate a natural pitch pattern used for text-to-speech synthesis.

### BACKGROUND OF THE INVENTION

Text-to-synthesis represents the artificial generation of a speech signal from an arbitrary sentence. An ordinary text-to-speech system consists of a language processing section, a control parameter generation section, and a speech signal generation section. The language processing section executes morpheme analysis and syntax analysis for an input text. The control parameter generation section processes accent and intonation, and outputs phoneme signs, pitch pattern, and the duration of phoneme. The speech signal generation section synthesizes the speech signal.

In the text-to-speech system, an element related to the naturalness of synthesized speech is the prosody processing of the control parameter generation section. In particular, pitch pattern influences the naturalness of synthesized speech. In known text-to-speech systems, pitch pattern is generated by a simple model. Accordingly, the synthesized speech is generated as mechanical speech whose intonation is unnatural.

Recently, a method to generate the pitch pattern by using a pitch pattern extracted from natural speech has been considered. For example, in Japanese Patent Disclosure (Kokai) “PH6-236197”, unit patterns extracted from the pitch pattern of natural speech or vector-quantized unit patterns are previously memorized. The unit pattern is retrieved from a memory by input attribute or input language information. By locating and transforming the retrieved unit pattern on a time axis, the pitch pattern is generated.

In the above-mentioned text-to-speech synthesis, it is impossible to store the unit patterns suitable for all input attributes or all input language informations. Therefore, transformation of the unit pattern is necessary. For example, elasticity of the unit pattern in proportion to the duration is necessary. However, even if the unit pattern is extracted from the pitch pattern of the natural speech, the naturalness of the synthesized speech falls because of this transformation processing.

### SUMMARY OF THE INVENTION

It is one object of the present invention to provide a speech information processing apparatus and a method to improve the naturalness of synthesized speech in text-to-speech synthesis.

According to the present invention, there is provided a speech information processing apparatus, comprising: a representative pattern memory means for storing a plurality of representative patterns corresponding to each cluster to which, a prosody unit belongs; a clustering means for classifying a plurality of prosody units in the speech data to each cluster according to attribute data of the prosody unit; an extraction means for extracting a pitch pattern corresponding to the prosody unit classified to each cluster from the speech data; a transformation parameter generation means for generating a transformation parameter by evaluating an error between the pitch pattern and the transformed representative pattern by unit of the cluster; and a representative pattern generation means for generating an updated representative pattern by calculating an evaluation function of the pitch pattern and the transformation parameter by unit of the cluster.

Further in accordance with the present invention, there is also provided a method for processing speech information, comprising the steps of: storing a plurality of representative patterns corresponding to each cluster to which the prosody unit belongs; classifying a plurality of prosody units in speech data to each cluster according to attribute data of the prosody unit; extracting the pitch pattern corresponding to the prosody unit classified to each cluster from the speech data; generating a transformation parameter by evaluating an error between the pitch pattern and the transformed representative pattern by unit of the cluster; and generating an updated representative pattern by calculating an evaluation function of the pitch pattern and the transformation parameter by unit of the cluster.

Further in accordance with the present invention, there is also provided a computer readable memory containing computer readable instructions, comprising: an instruction means for causing a computer to store a plurality of representative patterns corresponding to each cluster to which the prosody unit belongs; an instruction means for causing a computer to classify a plurality of prosody units in speech data to each cluster according to attribute data of the prosody unit; an instruction means for causing a computer to extract pitch pattern corresponding to the prosody unit classified to each cluster from the speech data; an instruction means for causing a computer to generate a transformation parameter by evaluating error between the pitch pattern and transformed representative pattern by unit of the cluster; and an instruction means for causing a computer to generate an updated representative pattern by calculating an evaluation function of the pitch pattern and the transformation parameter by unit of the cluster.

### BRIEF DESCRIPTION OF THE DRAWINGS

FIG. 1 is a block diagram of the speech information processing apparatus according to a first embodiment of the present invention.

FIG. 2 is a schematic diagram of examples of a prosody unit.

FIG. 3 is a block diagram of a generation apparatus of a pitch pattern and attribute.

FIG. 4 is a schematic diagram of the data format of a representative pattern selection rule in FIG. 1.

FIG. 5 is a schematic diagram of example of processing in a clustering section of FIG. 1.

FIGS. 6A-6E show examples of transformation of representative pattern according to the present invention.

FIG. 7 is a schematic diagram of a format of a transformation parameter generated by a transformation parameter generation section in FIG. 1.

FIG. 8 is a schematic diagram of the data format of a transformation parameter generation rule in FIG. 1.

FIG. 9 is a block diagram of the speech information processing apparatus according to a second embodiment of the present invention.

FIG. 10 is a schematic diagram of a format of error calculated by the error evaluation section in FIG. 9.

FIG. 11 is a block diagram of the speech information processing apparatus according to a third embodiment of the present invention.

### DETAILED DESCRIPTION OF THE PREFERRED EMBODIMENTS

Embodiments of the present invention will be explained referring to the Figures. In the embodiments, in general, the initial representative pattern is transformed in proportion to an input attribute, and an updated representative pattern is generated so that a pitch pattern generated from the transformed representative pattern is almost equal to a pitch pattern of natural speech. Furthermore, the pitch pattern of the input text is generated from the updated representative pattern. In short, the synthesized speech including naturalness similar to natural speech is generated.

First, technical terms used in the embodiments are explained.

A prosody unit is a unit of pitch pattern generation, which can include, for example, (1) an accent phrase, (2) a divided unit of the accent phrase into a plurality of sections by shape of the pitch pattern, and/or (3) a unit including boundary of continuous accent phrases. As for the accent phrase, a word may be regarded as the accent phrase. Otherwise, “an article+a word” or “a preposition +a word” may be regarded as the accent phrase.

The transformation of the representative pattern is the operation when generating the pitch pattern from the representative pattern, and includes, for example, (1) elasticity on a time axis, (2) elasticity or a parallel move on a frequency axis, (3) differentiation, integration or filtering, and/or (4) a combination of (1) (2) (3). This transformation is executed for a pattern in a time-frequency area or a time-logarithm frequency area.

A cluster corresponds to the representative pattern (initial pitch pattern) to which a plurality of prosody units belong. Clustering is the operation to classify the prosody unit to the cluster according to a predetermined standard. As the standard, an error between a pitch pattern generated from the representative pattern and a natural pitch pattern of the prosody unit, an attribute of the prosody unit, or a combination of the error and the attribute is used.

The attribute of the prosody unit is information related to the prosody unit or neighboring prosody unit extracted from speech data including the prosody unit or text corresponding to the speech data. For example, the attribute is the accent type, number of mora, part of speech, phoneme, or modification.

An evaluation function is a function to evaluate a distortion (error) of the pitch pattern generated from one representative pattern as for a plurality of the prosody units. For example, the evaluation function is a function defined between the generated pitch pattern and natural pitch pattern of the prosody units, or a function defined between the logarithm of the generated pitch pattern and the logarithm of the natural pitch pattern, which is used as a sum of the error squared.

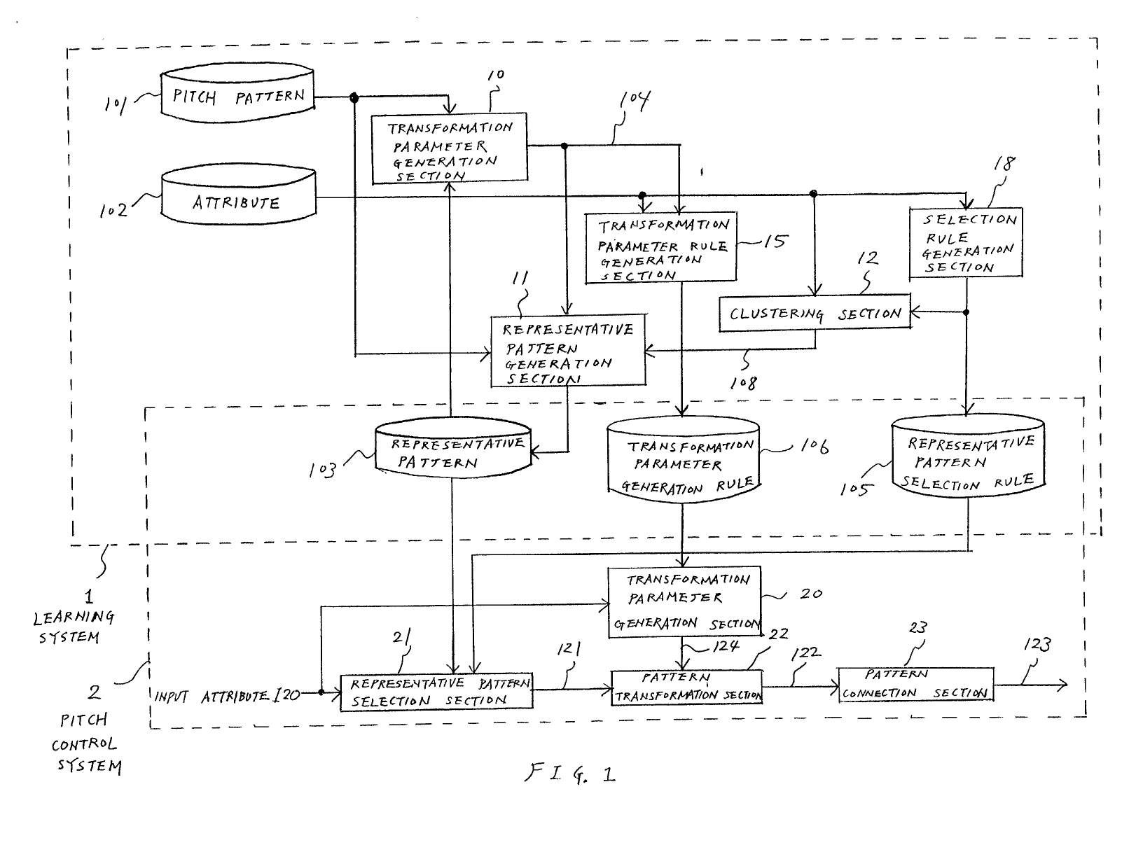

FIG. 1 is a block diagram of the speech information processing apparatus according to the first embodiment of the present invention. As shown in FIG. 1, the speech information processing apparatus is comprised of a learning system 1 and a pitch control system 2. The learning system 1 generates the representative pattern and the transformation parameter by learning in advance. The pitch control system 2 actually executes text-to-speech synthesis.

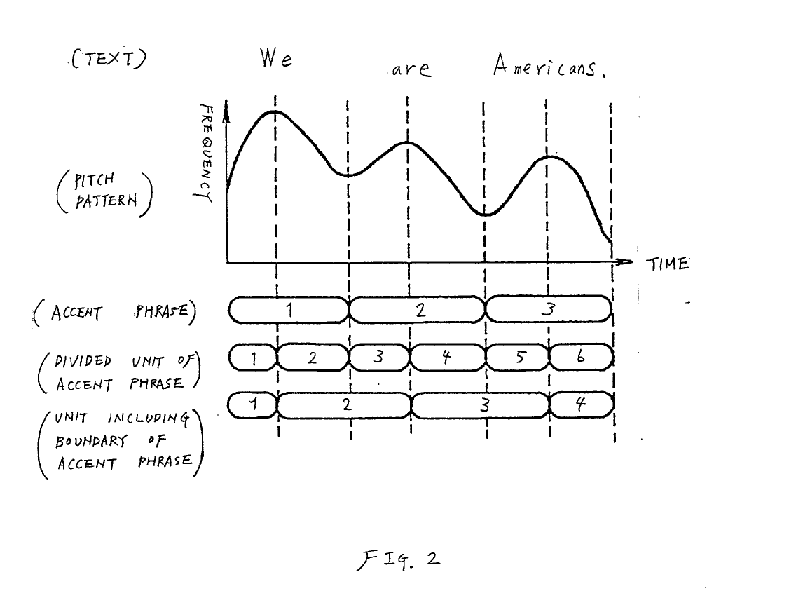

First, the learning system 1 is explained. The learning system 1 generates the representative pattern 103, a transformation parameter generation rule 106, and a representative pattern selection rule 105 by using a large quantity of pitch pattern 101 and the attribute 102 corresponding to the pitch pattern 101. In the first embodiment, assume that the prosody unit is an accent phrase. For example, as shown in FIG. 2, the accent phrases “We” “are” “Americans” are regarded as the prosody unit. However, the prosody unit may be regarded as a divided unit of the accent phrase, or a unit including the boundary of the accent phrase as shown in FIG. 2.

In the following explanation, assume that the number of the accent phrase in the pitch pattern memory 101 is N, the number of the representative pattern (number of cluster) in the representative pattern memory 103 is n, the pitch pattern of each accent phrase is represented as vector rⱼ (j=1, . . . , N), the representative pattern is represented as vector uᵢ (i=1, . . . , n). FIG. 3 is a block diagram of an apparatus to generate the pitch pattern 101 and the attribute 102. The speech data 111 represents a large quantity of natural speech data continuously uttered by many persons. The text 110 represents sentence data corresponding to the speech data 111. The text analysis section 31 executes morpheme analysis for the text 110, divides the text into the accent phrase unit, and assigns the attribute to each accent phrase unit. The attribute 102 is information related to the accent phrase or neighboring accent phrase, for example, the accent type, the number of mora, the part of speech, phoneme, or modification. A phoneme labeling section 32 detects the boundary between the phonemes according to the speech data 111 and corresponding text 110, and assigns phoneme label 112 to the speech data 111. A pitch extraction section 33 extracts the pitch pattern from the speech data 111. In short, the pitch pattern as the time change pattern of the fundamental frequency is generated for all text and outputted as sentence pitch pattern 113. An accent phrase extraction section 34 extracts the pitch pattern of each accent phrase from the sentence pitch pattern 113 by referring to the phoneme label 112 and the attribute 102, and outputs the pitch pattern 101.

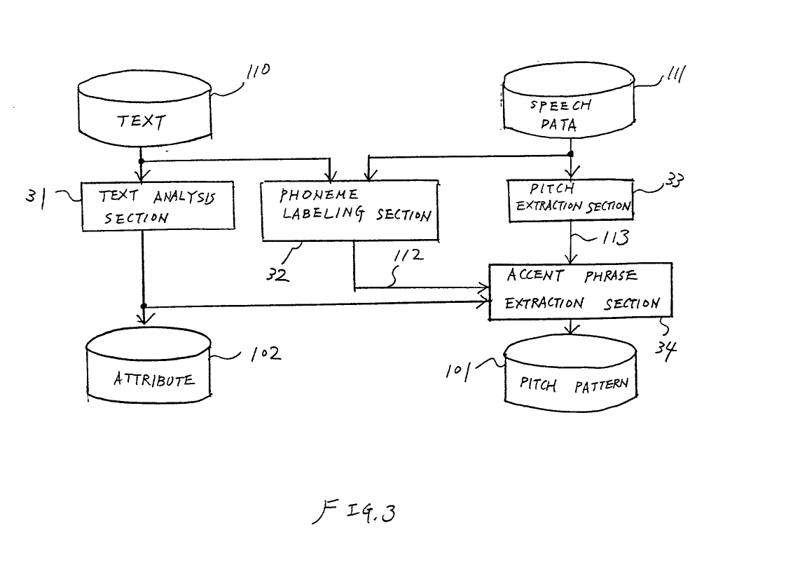

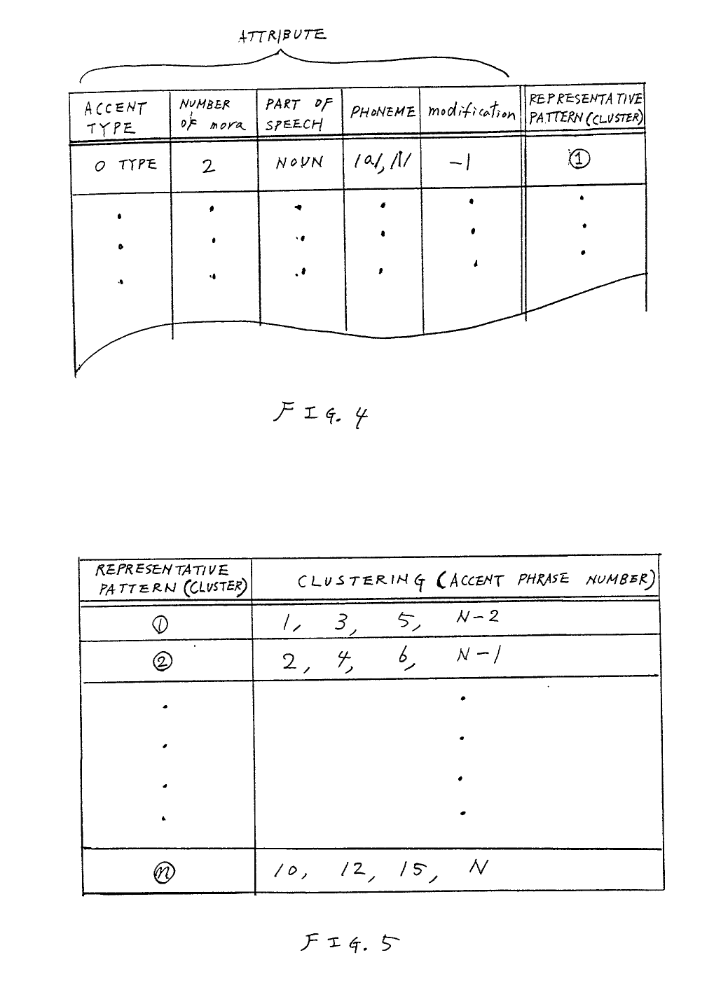

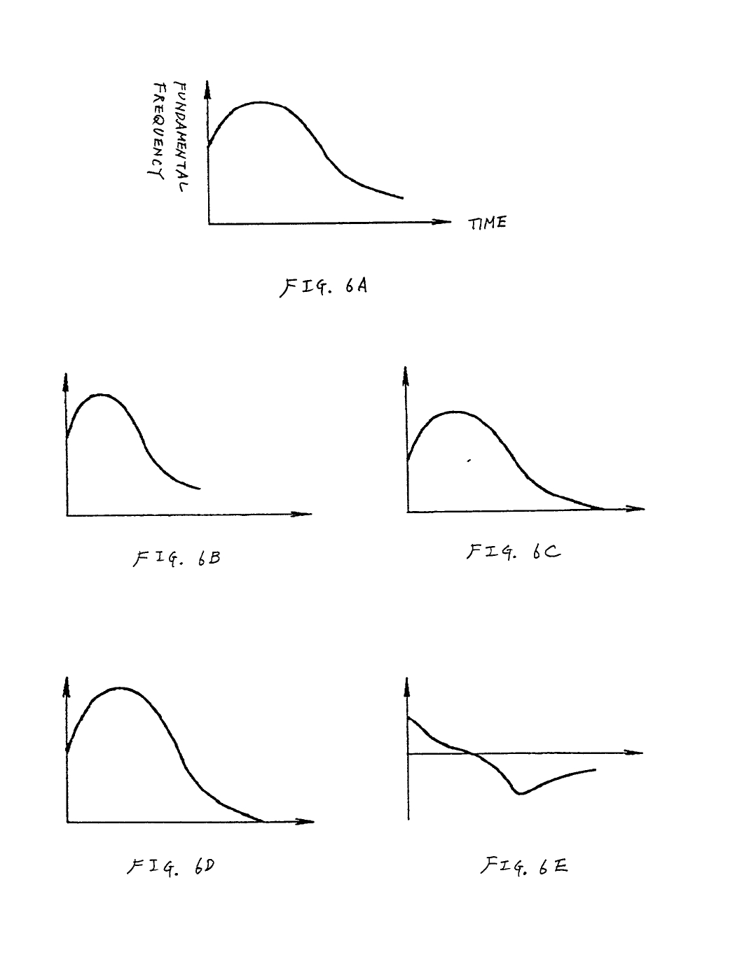

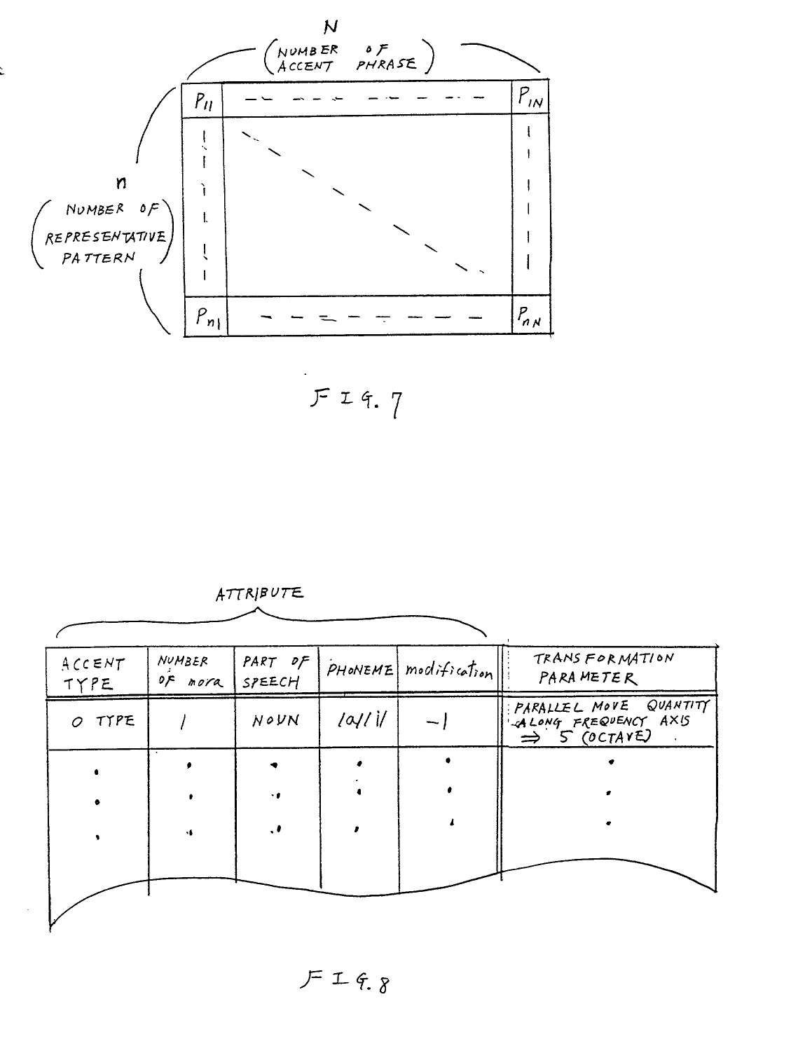

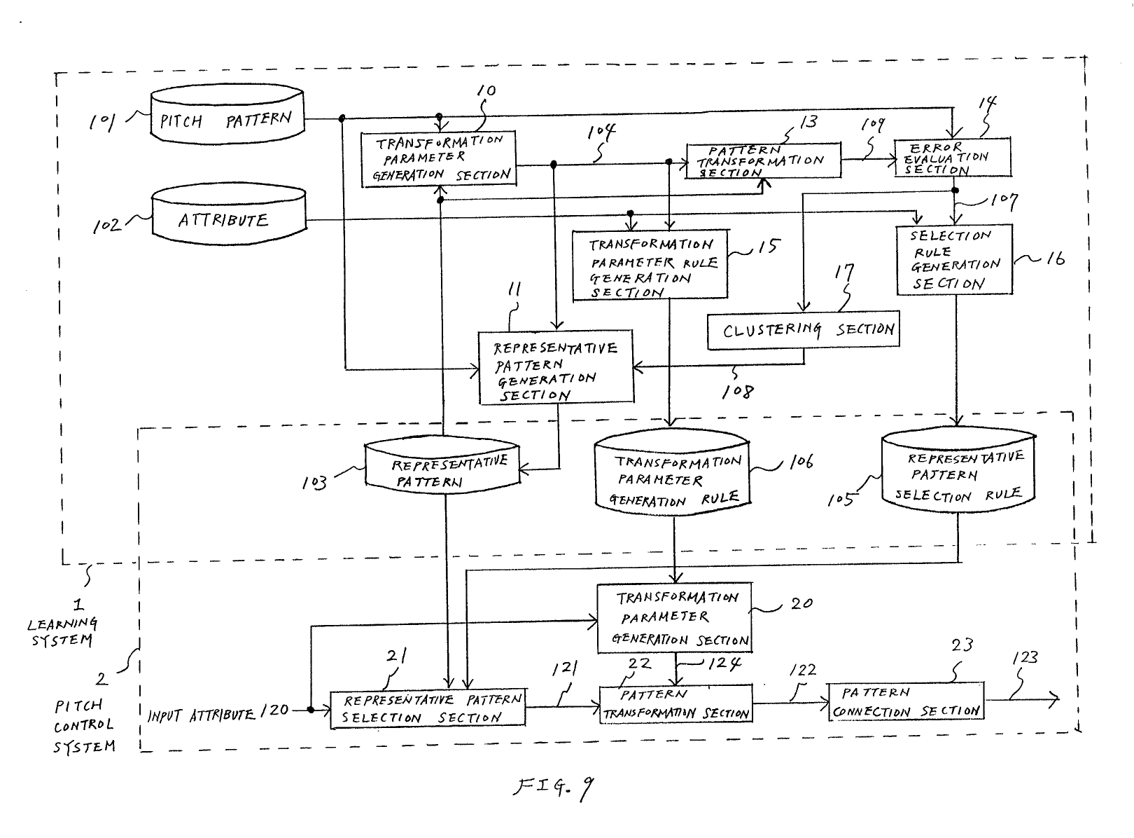

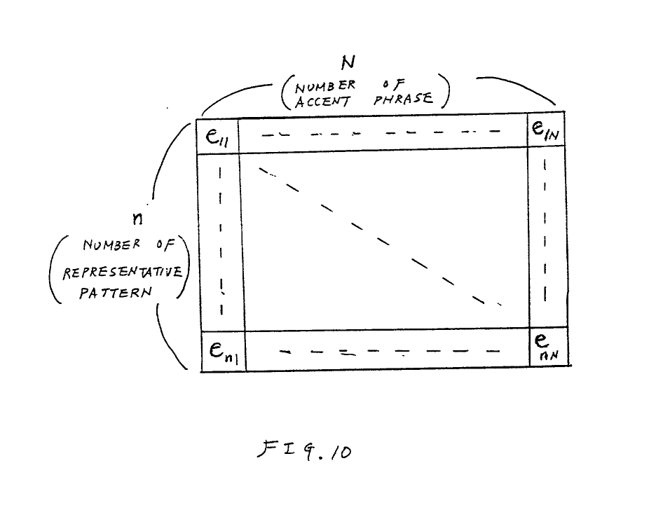

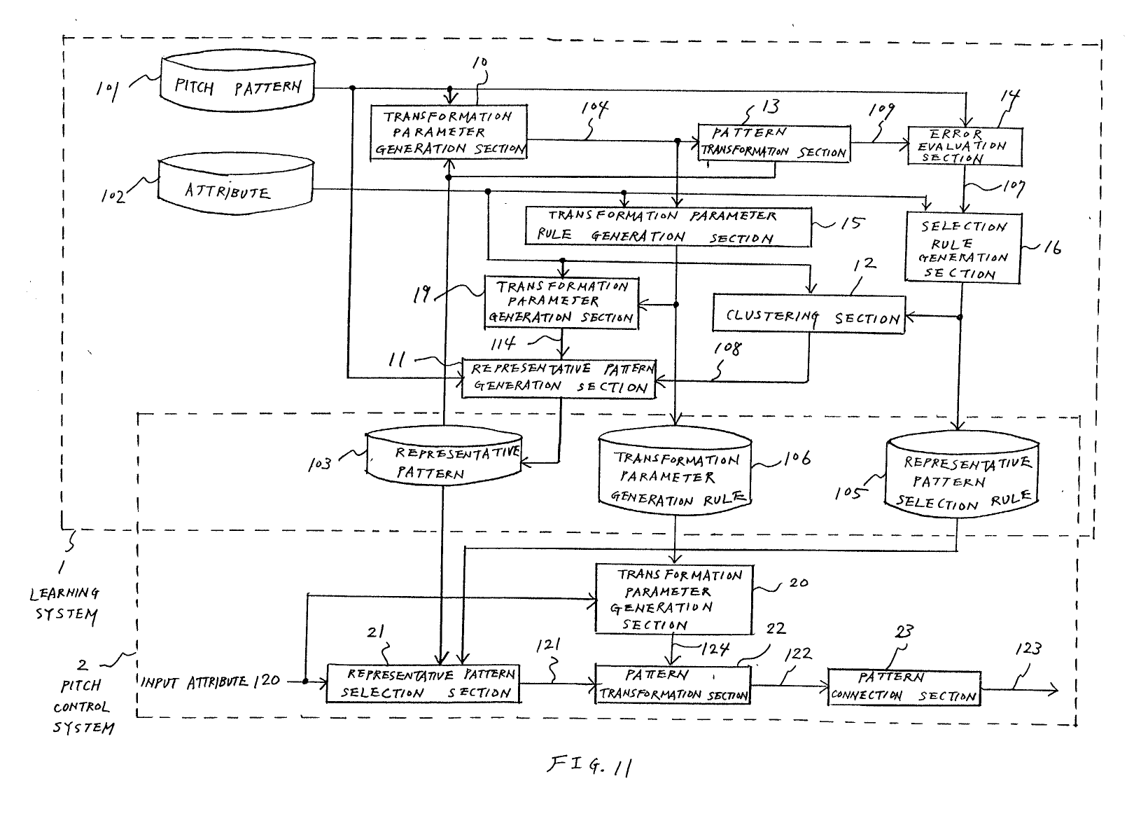

Next, the processing of the learning system 1 is explained in detail. In advance of the learning, assume that n units of the representative pattern are previously set. This representative pattern may include suitable characteristic prepared by foresight knowledge or may be used as noise data. First, a selection rule generation section 18 generates a representative pattern selection rule 105 by referring to the attribute of the accent phrase 102 and the foresight knowledge of the pitch pattern. FIG. 4 shows the data format of the representative pattern selection rule 105. As shown in FIG. 4, the representative pattern selection rule 105 is a rule to select the representative pattern by the attribute of the accent phrase. In short, the cluster to which the accent phrase belongs is determined by the attribute of the accent phrase or the attribute of the neighboring accent phrase. A clustering section 12 assigns each accent phrase to a cluster based on the attribute 102 of the accent phrase and the representative pattern selection rule 105. FIG. 5 is a schematic diagram of the clustering according to which each accent phrase (1˜N) is classified by unit of representative pattern (1˜n). In FIG. 5, each representative pattern (1˜n) corresponds to each cluster (1˜n). All accent phrases (1˜N) are classified into n clusters (representative patterns), and cluster information 108 is outputted. A transformation parameter generation section 10 generates the transformation parameter 104 so that the transformed representative pattern 103 closely resembles the pitch pattern 101.

The representative pattern 103 is a pattern representing the change in the fundamental frequency as shown in FIG. 6A. In FIG. 6A, a vertical axis represents a logarithm of the fundamental frequency. The transformation of the pattern is realized by a combination of the elasticity along the time axis, the elasticity along the frequency axis, the parallel movement along the frequency axis, differentiation, integration, and filtering. FIG. 6B shows an example of the elastic representative pattern along the time axis. FIG. 6C shows an example of the parallel movement of the representative pattern along the frequency axis. FIG. 6D shows an example of the elastic representative pattern along the frequency axis. FIG. 6E shows an example of a differentiated representative pattern. The elasticity along the time axis may be non-linear elasticity by using the duration while excluding the linear-elasticity. These transformations are executed for a pattern of the logarithm of the fundamental frequency or pattern of the fundamental frequency. Furthermore, as the representative pattern 103, a pattern representing inclination of fundamental frequency, which is obtained by differentiation of the pattern of fundamental frequency, may be used.

Assume that a combination of the transformation processing is a function “f( )”, the representative pattern is vector “u”, and the transformed representative pattern is vector “S” as follows.

S=f(p, u) (1)

A vector “Pᵢⱼ” as the transformation parameter 104 for the representative pattern “uᵢ” to closely resemble the pitch pattern “rⱼ” is determined to search “pᵢⱼ” to minimize the error “eᵢⱼ” as follows.

eᵢⱼ=(rⱼ−f(pᵢⱼ, uᵢ))^{T} (rⱼ−f(pᵢⱼ, uᵢ)) (2)

The transformation parameter is generated for each combination of all accent phrases (1˜N) of the pitch pattern 101 and all representative patterns (1˜n). Therefore, as shown in FIG. 7, n×N units of the transformation parameter Pᵢⱼ(i=1 . . . n) (j=1 . . . N) are generated. A representative pattern generation section 11 generates the representative pattern 103 by unit of the cluster according to the pitch pattern 101 and the transformation parameter 104. The representative pattern uᵢ of i-th cluster is determined by solving the following equation in which the evaluation function Eᵢ (uᵢ) is partially differentiated by uᵢ.

Eᵢ(uᵢ)=0 (3)

The evaluation function Eᵢ (uᵢ) represents the sum of errors when the pitch pattern rⱼ of the cluster closely resembles the representative pattern uᵢ. The evaluation function is defined as follows.

$${E}_{i} ( {u}_{i} ) = {\sum }_{j} {( {r}_{j} - f ( {p}_{ij} , {u}_{i} ) )}^{T} ( {r}_{j} - f ( {p}_{ij} , {u}_{i } ) ) \qquad ( 4 )$$

In above equation, “rⱼ” represents the pitch pattern belonging to i-th cluster. If the equation (4) is not partially differentiated, or the equation (3) is not analytically solved, the representative pattern is determined by searching “uᵢ” to minimize the evaluation function (4) according to the prior optimization method.

Generation of the transformation parameter by the transformation parameter generation section 10 and generation of the representative pattern 103 by the representative pattern generation section 11 is repeatedly executed till the evaluation function (4) converges.

A transformation parameter rule generation section 15 generates the transformation parameter generation rule 106 according to the transformation parameter 104 and the attribute 102 corresponding to the pitch pattern 101. FIG. 8 shows the data format of the transformation parameter generation rule 106. The transformation parameter generation rule is a rule to select the transformation parameter by input attribute of the pitch pattern, which is generated by a statistical method such as quantized I class or some inductive method.

Next, the pitch control system 2 is explained. The pitch control system 2 refers the representative pattern 103, the transformation parameter generation rule 106, and the representative pattern selection rule 105 according to input attribute 120 of each accent phrase. The attribute 120 is obtained by analysing the text inputted to the text-synthesis system. Then, the pitch control system 2 outputs the sentence pitch pattern 123 as pitch patterns of all sentences in the text. A representative pattern selection section 21 selects a representative pattern 121 suitable for the accent phrase from the representative pattern 103 according to the representative pattern selection rule 105 and the input attribute 120, and outputs the representative pattern 121. A transformation parameter generation section 20 generates the transformation parameter 124 according to the transformation parameter generation rule 106 and the input attribute 120, and outputs the transformation parameter 124. A pattern transformation section 22 transforms the representative pattern 121 by the transformation parameter 124, and outputs a pitch pattern 122 (transformed representative pattern). Transformation of the representative pattern is executed in the same way as the function “f( )” representing a combination of transformation processing defined by the transformation parameter generation section 10. A pattern connection section 23 connects the pitch pattern 122 of the continuous accent phrases. In order to avoid discontinuity of the pitch pattern at the connected part, the pattern connection section 23 smooths the pitch pattern at the connected part, and outputs the sentence pitch pattern 123.

As mentioned-above, in the first embodiment, by unit of the cluster to which the attribute is affixed, the updated representative pattern is generated by the evaluation function of the error between a pitch pattern (the transformed representative pattern) transformed from last representative pattern and the natural pitch pattern corresponding to each attribute of natural speech in the learning system 1. Furthermore, in the pitch control system 2, a pitch pattern of text-to-speech synthesis is generated by using the representative pattern. Therefore, synthesized speech that is highly natural is outputted without unnaturalness because of transformation.

FIG. 9 is a block diagram of the speech information processing apparatus according to the second embodiment of the present invention. In the second embodiment, a clustering method of the pitch pattern and a generation method of the representative pattern selection rule are different than in the first embodiment. In short, in the first embodiment, the representative pattern selection rule is generated according to the foresight, knowledge, and distribution of the attribute, and a plurality of accent phrases are classified according to the representative pattern selection rule. However, in the second embodiment, based upon the error between a pitch pattern transformed from the representative pattern and the natural pitch pattern extracted from the speech data, a plurality of accent phrases are classified (clustering) and the representative pattern selection rule is generated.

First, the transformation parameter generation section 10 generates the transformation parameter 104 so that a pitch pattern transformed from the representative pattern 103 closely resembles the pitch pattern 101. Next, a clustering method of the pitch pattern is explained in detail. A pattern transformation section 13 transforms the representative pattern 103 according to the transformation parameter 104, and outputs the pitch pattern 109 (transformed representative pattern). Transformation of the representative pattern is executed by the function “f( )” as a combination of the transformation processing defined by the transformation parameter generation section 10. As for the pitch pattern rⱼ (j=1 . . . N) of N units of accent phrase, n units of the pitch pattern sᵢⱼ (i=1 . . . n) (j=1 . . . N) are generated by transforming n units of the representative pattern uᵢ (i=1 . . . n). The error evaluation section 14 evaluates an error between the pitch pattern 101 and the pitch pattern 109, and outputs the error information 107. The error is calculated as follows.

eᵢⱼ=(rⱼ−sᵢⱼ)^{T} (rⱼ−sᵢⱼ) (5)

The error eᵢⱼ is generated for each combination of all accent phrases of the pitch pattern 101 and all of the representative pattern 103. FIG. 10 is a schematic diagram of the format of the error calculated by the error evaluation section. As shown in FIG. 10, n×N units of the error “eᵢⱼ” (i=1 . . . n) (j=. . . N) are generated. The clustering section 17 classifies N units of the pitch pattern 101 to n units of the cluster corresponding to the representative pattern according to the error information 107 in the same way as FIG. 5, and outputs the cluster information 108. If the cluster corresponding to the representative pattern uᵢ is represented as Gᵢ, the pitch pattern rⱼ is classified (clustering) by the error eᵢⱼ as follows.

Gᵢ={rⱼ|eᵢⱼ=min[eᵢⱼ, . . . , eₙⱼ]} (6)

min[X₁, . . . , Xₙ]: minimum value of (X₁, . . . , Xₙ)

Then, the representative pattern generation section 11 generates the representative pattern 103 according to the pitch pattern 101 and the transformation parameter 104 by unit of the cluster 108. In the same way as the first embodiment, the generation of the transformation parameter, the clustering, and the generation of the representative pattern are repeatedly executed until the evaluation function (4) converges. When the above-mentioned processing is completed, the transformation parameter rule generation section 15 generates the transformation parameter generation rule 106, and the selection rule generation section 16 generates the representative pattern selection rule 105. In this case, when the evaluation function (4) converges, the selection rule generation section 16 generates the representative pattern selection rule 105 by the error information 107 of the convergence result and the attribute 102 of the pitch pattern 101. As shown in FIG. 4, the representative pattern selection rule 105 is a rule to select the representative pattern by the attribute, which is generated by a statistical method such as quantized I class or some inductive method.

As mentioned-above, in the learning system of the second embodiment, whenever the errors between each combination of all pitch patterns transformed from the representative patterns and all pitch patterns of natural speech are generated as shown in FIG. 10, each pitch pattern of natural speech is classified to the cluster. Whenever this clustering is executed, the updated representative pattern 103 is generated for each cluster. When the evaluation function of the error is converged, the representative pattern selection rule 105 and the transformation parameter generation rule 106 are stored as the convergence result. Then, in the pitch control system, a suitable representative pattern 103 corresponding to input attribute is selected by referring to the representative pattern selection rule 105, and the selected representative pattern is transformed by referring to the transformation parameter generation rule 106 in order to generate a sentence pitch pattern. Therefore, synthesized speech similar to natural speech is outputted by using the sentence pitch pattern.

FIG. 11 is a block diagram of the speech information processing apparatus according to the third embodiment of the present invention. In the third embodiment, the transformation parameter to input to the representative pattern generation section 11 and a generation method of the cluster information are different from the first and second embodiments. In short, in the first and second embodiments, the updated representative pattern is generated by using suitable transformation parameter generated from the representative pattern 103 and the pitch pattern 101. However, in the third embodiment, the representative pattern is updately generated by using the transformation parameter generated from the transformation parameter generation rule 106 and the pitch pattern 101.

In the third embodiment, the transformation parameter generation section 19 generates the transformation parameter 114 according to the last transformation parameter generation rule 106 and the attribute 102. The representative pattern generation section 11 generates the representative pattern according to the transformation parameter 114 and the pitch pattern 101.

Whenever the error evaluation section 14 evaluates the errors between each combination of all pitch patterns transformed from the representative patterns and all pitch patterns of natural speech are generated as shown in FIG. 10, the selection rule generation section 16 generates the representative pattern selection rule 105 according to the evaluated error and the attribute 102 as shown in FIG. 4. The clustering section 12 determines the cluster to which the pitch pattern 101 is classified according to the representative pattern selection rule 105 and the attribute 102 of each pitch pattern 101. By classifying all pitch patterns 101 to n units of the cluster corresponding to the representative pattern, the clustering section 12 outputs cluster information 108 as shown in FIG. 5.

In short, in the third embodiment, a generation of the transformation parameter, a generation of the transformation parameter generation rule, a generation of the representative pattern selection rule, the clustering, and the generation of the representative pattern are executed as a series of processings. In this case, the generation of the transformation parameter generation rule is independently executed at arbitrary timing from the generation of the representative pattern selection rule and the clustering if a generation timing of the transformation parameter generation rule is located between the generation of the transformation parameter and the generation of the representative pattern. This series of processings is repeatedly executed till the evaluation function (4) is converged. After the series of processings is completed, the transformation parameter generation rule 106 and the representative pattern selection rule 105 at the timing are respectively adopted. Furthermore, these rules may be calculated again by using the representative pattern obtained last.

As mentioned-above, in the learning system of the third embodiment, whenever the error between each combination of all pitch patterns transformed from the representation patterns and all pitch patterns of natural speech are generated as shown in FIG. 10, the representation pattern selection rule 105 is generated according to the evaluated error and the attribute 102 as shown in FIG. 4, and each pitch pattern of natural speech is classified to the cluster as shown in FIG. 5. Whenever this clustering is executed, the updated representation pattern 103 is generated for each cluster. When the evaluation function of this error converges, the transformation parameter generation rule 106 and the representation pattern section rule 105 at this timing are adopted as the convergence result. Then, in the pitch control system, a suitable representative pattern 103 corresponding to the input attribute is selected by referring to the representative pattern selection rule 105, and the selected representative pattern is transformed by referring to the transformation parameter generation rule 106 in order to generate a sentence pitch pattern. Therefore, synthesized speech similar to natural speech is outputted by using the sentence pitch pattern.

In the first, second, and third embodiments, the speech information processing apparatus consists of the learning system 1 and the pitch control system 2. However, the speech information processing apparatus may consist of the learning system 1 only, the pitch control system 2 only, the learning system 1 excluding memory of the representative pattern 103, the transformation parameter generation rule 106 and the representative pattern selection rule 105, or the pitch control system 2 excluding memory of the representative pattern 103, the transformation parameter generation rule 106 and the representative pattern selection rule 105.

A memory can be used to store instructions for performing the process of the present invention described above, such a memory can be a hard disk, semiconductor memory, and so on.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. Speech information processing apparatus, comprising:
representative pattern memory means for storing a plurality of representative pitch patterns from natural speech data and attribute data corresponding to representative pitch patterns, the representative pitch pattern as being arranged by prosody units;
clustering means for classifying a plurality of prosody units to a cluster according to attribute data of each of the the prosody units;
extraction means for extracting a generated pitch pattern corresponding to the prosody units classified to the cluster;
transformation parameter generation means for generating a transformation parameter by evaluating an error between the generated pitch pattern and a transformed representative pattern; and
representative pattern generation means for generating an updated representative pattern by calculating an evaluation function of the generated pitch pattern and the transformation parameter.

2. The speech information processing apparatus according to claim 1,
wherein the prosody unit is one of an accent phrase, a divided unit of the accent phrase, and a unit including a boundary of continuous accent phrase.

3. The speech information processing apparatus according to claim 1,
wherein the transformation parameter represents one of elasticity along a time axis, and elasticity or parallel movement along a frequency axis.

4. The speech information processing apparatus according to claim 1,
wherein the attribute data includes accent type, number of mora, part of speech, phoneme, or modification of the prosody unit.

5. The speech information processing apparatus according to claim 1,
wherein said transformation parameter generation means repeates generation of the transformation parameter, and said representative pattern generation means repeates update of the representative pattern, until the evaluation function satisfies a predetermined condition.

6. The speech information processing apparatus according to claim 5,
wherein said representative pattern generation means stores the representative pattern in said representative pattern memory means when the evaluation function satisfies the predetermined condition.

7. The speech information processing apparatus according to claim 6,
further comprising a transformation parameter generation rule memory means for storing the transformation parameter and corresponding attribute data when the evaluation function satisfies the predetermined condition.

8. The speech information processing apparatus according to claim 5,
further comprising an error evaluation means for calculating an error between each pitch pattern and the transformed representative pattern whenever said transformation parameter generation means generates the transformation parameters for all pitch patterns by unit of the clusters, and
wherein said clustering means classifies each pitch pattern to the cluster of which corresponding error is below a threshold.

9. The speech information processing apparatus according to claim 8,
further comprising a representative pattern selection rule memory means for storing the attribute data corresponding to classified pitch pattern by unit of the cluster when the evaluation function satisfies the predetermined condition.

10. The speech information processing apparatus according to claim 9,
wherein said representative pattern selection rule memory means stores the attribute data corresponding to classified pitch pattern by unit of the cluster whenever said clustering means classifies all pitch patterns to the cluster according to the error and the attribute data.

11. A method for processing speech information, comprising the steps of:
storing a plurality of representative pitch patterns from natural speech and attribute data corresponding representative pitch patterns, the representative pitch patterns being arranged by prosody units;
classifying a plurality of prosody units to a cluster according to attribute data of each of the prosody units;
extracting a generated pitch pattern corresponding to the prosody units classified to the cluster;
generating a transformation parameter by evaluating an error between the generated pitch pattern and a transformed representative pattern; and
generating as updated representative pattern by calculating an evaluation function of the generated pitch pattern and the transformation parameter.

12. The method for processing speech information according to claim 11,
wherein the prosody unit is one of an accent phrase, a divided unit of the accent phrase, and a unit including a boundary of continuous accent phrase.

13. The method for processing speech information according to claim 11,
wherein the transformation parameter represents one of elasticity along a time axis, and elasticity or parallel movement along a frequency axis.

14. The method for processing speech information according to claim 11,
wherein the attribute data includes accent type, number of mora, part of speech, phoneme, or modification of the prosody unit.

15. The method for processing speech information according to claim 11,
further comprising the steps of:
repeating the generation of the transformation parameter and updating of the representative pattern until the evaluation function satisfies a predetermined condition.

16. The method for processing speech information according to claim 15,
further comprising the step of:
storing the representative pattern when the evaluation function satisfies the predetermined condition.

17. The method for processing speech information according to claim 16,
further comprising the step of:
storing the transformation parameter and corresponding attribute data when the evaluation function satisfies the predetermined condition.

18. The method for processing speech information according to claim 15,
further comprising the steps of:
calculating an error between each pitch pattern and the transformed representative pattern whenever the transformation parameters for all pitch patterns by unit of the clusters are generated at the step of generating a transformation parameter; and
classifying each pitch pattern to the cluster of which corresponding error is below a threshold.

19. The method for processing speech information according to claim 18,
further comprising the step of:
storing the attribute data corresponding to classified pitch pattern by unit of the cluster when the evaluation function satisfies the predetermined condition.

20. The method for processing speech information according to claim 19,
further comprising the step of:
storing the attribute data corresponding to classified pitch pattern by unit of the cluster whenever all pitch patterns are classified to the cluster according to the error and the attribute data at the step of classifying each pitch pattern.

21. A computer readable memory containing computer readable instructions, comprising:
instruction means for causing a computer to store a plurality of representative pitch patterns from natural speech data and attribute data corresponding to representative pitch pattern, the representative pitch patterns being arranged by prosody units;
instruction means for causing a computer to classify a plurality of prosody units to a cluster according to attribute data of each of the prosody units;
instruction means for causing a computer to extract a generated pitch pattern corresponding to the prosody units classified to the cluster;
instruction means for causing a computer to generate a transformation parameter by evaluating an error between the generated pitch pattern and a transformed representative pattern; and
instruction means for causing a computer to generate an updated representative pattern by calculating an evaluation function of the generated pitch pattern and the transformation parameter.
